(19) United States
(12) Patent Application Publication
(10) Pub. No.: US 2014/0265194 A1
(43) Pub. Date: Sep. 18, 2014

(54) Self-contained janitorial caddy

(71) Applicant: CHRISTOPHER GWIN, BETHESDA, MD (US)

(72) Inventor: CHRISTOPHER GWIN, BETHESDA, MD (US)

(21) Appl. No.: 13/815,718

(22) Filed: Mar. 15, 2013

(51) Int. Cl. B62B 3/10

(52) U.S. Cl. CPC B62B 3/104
USPC 280/47.34; 280/79.5

(57) ABSTRACT

A self-contained janitorial tool caddy is disclosed. The tool caddy has an inner circular element which can be in the shape of a cylinder. This inner circular element fits around the base of a standard commercial trash barrel. The inner circular element has one or more outwardly disposed compartments designed to hold janitorial tools and supplies. The tool caddy has a base, to which wheels are directly attached, allowing the caddy to move freely about, without having to be mounted on a separate wheeled structure. In another embodiment the base extends beyond the diameter of the outer element of the caddy, thereby giving more stability to the entire assembly.

### BACKGROUND

Janitorial service providers commonly collect trash, dust, sweep, and perform light washing and kitchen clean-up. These providers employ specialized tools and products in providing these services. A commonly used tool is a commercial trash barrel. Such a trash barrel is available in a standard 44-gallon size and has the approximate shape of a tapered cylinder. Typical dimensions of the trash barrel are 20-inch diameter at its base, 24-inch diameter at its top and a height of 32 inches. The trash barrel accepts a flexible plastic trash barrel liner that keeps the trash barrel clean and facilitates removal of trash. The trash barrel has a screw fitting protruding from its base. It is to this screw fitting that a separate five wheel dolly attaches allowing the barrel to be maneuvered while performing its task.

In addition to the trash barrel/wheeled dolly combination, the service provider carries an assortment of tools and cleaning supplies useful in performing assigned tasks. Such tools may include brooms, brushes and cleaning cloths, and such supplies may include spray cleaners, soaps and polishes. Oftentimes a service provider carries tools and supplies in a makeshift fashion by hanging them from the trash barrel or placing them inside the trash barrel. A makeshift approach can leave the provider's tools and supplies disorganized, unsecured, difficult to access and hard to keep track of. In addition, the tools and supplies may interfere with removal and replacement of the flexible plastic trash barrel liner. It is desirable to carry such tools and supplies organized and secure in a tool caddy attached to the trash barrel in a manner that does not interfere with removal and replacement of the flexible plastic trash barrel liner.

A tool caddy that protrudes outward from a trash barrel reduces the maneuverability of the trash barrel. A compromise exists between designing a tool caddy large enough to provide adequate storage space, but not so large as to substantially reduce the maneuverability of the trash barrel.

### SUMMARY OF THE DISCLOSURE

The present disclosure is for a self-contained caddy which wheels are attached for easy maneuverability. In one embodiment, the caddy contains a top surface section having a circular opening through its center, said diameter of said circular opening being slightly larger than the diameter of a trash barrel allowing the barrel to be placed inside the caddy.

In another embodiment of the disclosure, there is a plurality of other smaller openings at least partially surrounding the circular opening of the top surface section. These smaller openings of said top section are enclosed, such that said openings are compartmentalized. There is also an outer perimeter wall, wherein a top of the outside wall is connected to said top surface section, as well as an inner circular element. The top of the inner circular element is connected to the top of the opening of said top surface section, therein forming an annulus. There is also a bottom section is attached to and covers the bottom section of the outer wall.

In another embodiment, the garbage barrel fits into the annulus, and tools and other implements fit into the smaller openings, said smaller openings at least partially surrounding the opening to the annulus.

In one embodiment, the bottom section of the caddy is integrally molded with the rest of the caddy.

In another embodiment, the bottom section of the caddy is glued to the inside circular element and the outside circular element.

In another embodiment of the disclosure, the caddy is made out of metal, and the bottom section is welded to the inside circular element and outside circular element.

In another embodiment of the disclosure, wheels are attached to the underside of the bottom section.

In yet another embodiment of the disclosure, the circular element has handles that insert into which to push or drag the garbage can and caddy, and legs that pivot from the handles to allow the barrel to be leaned over at an angle and stabilized, facilitating the removal of heavy trash from the barrel.

### IN THE DRAWINGS

The disclosure will be better understood and objects other than those set forth above will become apparent when consideration is given to the following detailed description thereof. Such description makes reference to the annexed drawings wherein:

FIG. 1 is a perspective view of the self contained caddy;

FIG. 2 is a top view of the self contained caddy;

FIG. 3 is a side view of the self contained caddy;

FIG. 4 is an exploded side elevation of the present disclosure including the trash barrel;

FIG. 5 is a side vie of the present disclosure assembled with the trash barrel and wheeled dolly.

### DETAILED DESCRIPTION OF THE DISCLOSURE

Referring to FIG. 1-7, the self contained janitorial caddy 1 is comprised of plastic or rubber. In some cases, the caddy may also be comprised of a metal, wood, or a paper product such as compressed cardboard, with a water resistant finish. A soft material such as rubber or plastic will limit any damaged caused when the caddy invariably bumps into a wall or door during use.

The caddy itself is comprised of a drum 100, the drum 100 having an inner wall 2. The circumference of the inner wall 2 is circular or square to conform to the shape of the average trash barrel 14. If any other trash barrels have different shapes now or in the future, the circumference of alternative embodiments of the inner wall 2 will be marketed with the inner wall 2 to conform to different shaped trash containers.

The drum 100 also has an outer wall 5. The outer wall 5 is square, rectangle, oval, circular, or any other shape. In one embodiment of the caddy, the outer wall is circular with one flat side 10 near the back end of the caddy, so that the drum 100 does not interfere with service person pushing the caddy/trash barrel

The drum 100 also has a top surface section 4 which bridges the outer wall 5 and the inner wall 2. There are pockets 8 in the top surface section 4 into which tools, bottles of cleaning solutions, etc. can be fitted. These pockets are integrally molded with the top surface section. More specifically, the opening pockets 8 may be part of a single plastic mold with the entire caddy 1.

In one embodiment, the pockets go all away around the circumference of the inner wall 2. In another embodiment, the pockets do not go around the back flat section of the caddy.

The self contained janitorial caddy 1 also has a platform 24 attached directly to the bottom 25 of the outer wall 5. In another embodiment, platform 24 is attached to both the bottom 25 of the outer wall 5 and to the bottom 26 of the inner wall 2. In another embodiment, the platform 24 is only attached to the bottom 26 of the inner wall 2. In yet another embodiment, the platform 24 may be integrally molded with the bottom of either or both of outer wall 5 or inner wall 2. In an alternative embodiment, the platform 24 is attached by glue. In yet another embodiment nuts and bolts, or screws and nuts connect the platform 24 to either or both of the bottom sections of the outer wall 5 or inner wall 2. In one embodiment, the platform extends only to the and including the bottom of the inner wall 2, while in another embodiment the platform extends to the outer edges of the outer wall 5.

The platform 24 has a top side 101 and an underside 102. The top side has a centrally located raised circular section 103 having bayonet locks 104 which mesh with the bottom of the trash can, thereby locking the trash can in place.

In one embodiment of the disclosure, at least three wheels 30, 31, 32, and up to five or six wheels or more, 30, 31, 32, 33, 34 are attached to the underside 102 of the platform 24, so that when a trash can is positioned within the self-contained janitorial caddy, the caddy can be easily rolled on a variety of surfaces. Any sort of wheels will do, including casters of almost any kind. The wheels may be attached by any known method, including being mounted to plastic projections into which screws fit. The wheels may also be glued to the underside 102 of the of the platform 24 or an extension of the caster has a rim is pushed into a plastic opening past a rim or section within the opening such that the caster cannot be removed from the underside of the platform. Any known method can be used to affix the wheels or castors to the underside of the platform.

In one embodiment, the three or more wheels are attached to the underside 102 of the platform 24 at a position corresponding to the edge of the inner wall 2. In another embodiment the underside of the platform extends to the edge of the outer rim, and the wheels are positioned at a spot corresponding to at or near the outer wall 5 of the drum. In yet another embodiment, the wheels are attached to plastic molded clips or extensions 105 of the underside 106 of the drum.

The wheels may be positioned equidistant from each other, can be in a diamond formation, a square formation, or a “round” formation. They may be positioned at the outer circumference of the underside of the platform, or positioned inwardly towards the center, underneath the area of the locking bayonet.

The platform 24 may be round 41 or square, and may be integrally molded with either the inner wall 3 or the outer wall 5. The platform 24 has side sections 42, 43, 44, and 45.

In another embodiment, the caddy can also have a handle and leg support arrangement. In one embodiment, there are swinging legs 49, 50, which are attached to attachment bars 53, 55. The distal ends of attachment bars 53, 55 are positioned angularly through opening 300, 301 in the top of the drum, and may be affixed by any means known in the art. The swing legs 49, 50 are attached to the outside or inside of the attachment bars and can swing freely. They may be attached by any means that allows for free movement of the legs, allowing for support of the assembly when tilted, particularly when there is a trash barrel positioned in the caddy. In another embodiment, attachment bars 53 55 are attached to each other by means of a cross bar 120 which may be positioned between and through swinging legs 49, 50. The proximal ends of the attachment bars 53, 55 are connected by a handle 51, which the user may grasp and use to push the entire assembly.

In another embodiment, clips 70 may be attached or integrally molded into the cross bar and the attachment bars in order to hold rags, additional brushes, etc.

As shown in the figures tool caddy is configured so that the standard commercial trash barrel 200 can reside in the annulus created by the tool caddy's inner wall 2. A standard commercial trash barrel 200 designed to accept a standard commercial wheeled dolly. In one embodiment, a pressure-fit or screw-fit element on the bottom of the trash barrel mates with a corresponding element on the wheeled dolly.

While the disclosure has been described in conjunction with specific embodiments, it is evident that many alternatives, modifications and variations will be apparent to those skilled in the art in light of the foregoing description. Accordingly, the present disclosure attempts to embrace all such alternatives, modifications and variations that fall within the spirit and scope of the appended claims.

We claim:

1. A self-contained janitorial tool caddy, said self-contained tool caddy comprising:
a) a drum section, said drum comprising:
i) an inner wall, the inner wall confirming to a shape of the trash barrel;
ii) an outer wall;
iii) a top surface section, said section bridging the outer wall and the inner wall;
A) openings in the top surface section;
iv) an underside of said drum section;
b) a platform upon which the cylindrical section is attached, said platform having a top section and an underside; and
c) at least three wheels attached to said underside of either said underside of said platform or said underside of said drum section.

2. The self-contained janitorial tool caddy of claim 1, wherein a shape of the outer wall is selected from the group consisting of square, rectangle, oval, and circular.

3. The self-contained janitorial tool caddy of claim 1, wherein the outer wall is circular with a one flat side near the back end of the caddy.

6. The self-contained janitorial tool caddy of claim 1, wherein said platform is integrally molded with a bottom section of said drum.

7. The self-contained janitorial tool caddy of claim 1, further comprising pockets fitted into said openings of said surface section.

8. The self-contained janitorial tool caddy of claim 1, further comprising at least four wheels.

9. The self-contained janitorial tool caddy of claim 1, further comprising at least five wheels.

10. The self-contained janitorial tool caddy of claim 1, wherein said platform fits within the circumference of the inner wall.

11. The self-contained janitorial tool caddy of claim 1, wherein said platform extends to the circumference of the outer wall.

12. The self-contained janitorial tool caddy of claim 1, further comprising at least one handle.

13. The self-contained janitorial tool caddy of claim 12, further comprising at least one grip bar.

14. The self-contained janitorial tool caddy of claim 13, further comprising legs that swing out from the handle or grip bar to allow the barrel to be stabilized, when tilted at an angle, to facilitate the removal of heavy trash.

15. The self contained janitorial tool caddy of claim 13, further comprising at least one mechanism from the handle or grip bar to allow the attachment of a dust pan and that would rest on the dolly below.
